(19) United States
(12) Patent Application Publication
(10) Pub. No.: US 2024/0202536 A1
(43) Pub. Date: Jun. 20, 2024

(54) Neural Network-Based Method for Detecting Validity of Human Movement

(71) Applicant: FindSatoshi Lab Limited, Tortola (VG)

(72) Inventor: Yan Rong, Hyde Park (AU)

(21) Appl. No.: 18/083,802

(22) Filed: Dec. 19, 2022

(51) Int. Cl. G06N 3/091; G06F 40/126; G06F 40/40

(52) U.S. Cl. CPC G06N 3/091; G06F 40/126; G06F 40/40

(57) ABSTRACT

The present disclosure relates to a neural network-based method for detecting validity of a human movement, comprising, obtaining a user movement dataset; extracting a feature text based on the user movement dataset; wherein the feature text comprises a plurality of input sequences, and each of the plurality of input sequences comprises at least a direction, a distance, and a step count; transforming the feature text into a first initial encoding according to a preset coding rule; and inputting the first initial encoding into an auto-encoder neural network-based detection model to determine whether the human body movement corresponding to the user movement dataset is valid.

### TECHNICAL FIELD

The present disclosure relates to the field of movement monitoring, and more specifically to a neural network-based method for detecting the validity of human movement.

### BACKGROUND ART

One of the basic daily activities for most people is moving around. In order to encourage people to walk more, a possible way is to monitor human body movements by using smart devices such as wristbands, and provide rewards based on the generated movement records. Typical human body movements comprise walking, jogging, or running. For example, by jogging outdoors, a user will earn game coins to be used in games or be cashed out for profit. Through this kind of financial gamification (Game-Fi), millions of people can be driven towards a healthier lifestyle and to fight climate change.

However, the commonly used methods for monitoring human body movement today are usually through step counting by mobile devices, GPS path tracking, or a combination of both. For example, one of the commonly used methods is to count the steps via smart wearables. However, this scheme has defects such as poor robustness and susceptibility to being spoofed. For example, Chinese patent CN108332770B discloses a method for preventing cheating in step counting, according to which the technical solution determines whether step counting is a suspected cheating according to the increment of steps in each preset time interval. This scheme is prone to false alarm on the one hand, for example, the user's speed change during running may be misunderstood as suspected cheating; on the other hand, it may not be able to give accurate determination in time for some artificial manipulation of a device for invalid activity recording, for example, using a mechanical device to fix and shake a smart device to simulate walking.

Therefore, there is a great need in the field for a solution that can at least reliably detect the validity of human body movement, so as to determine whether the user has actually performed a valid movement. It should be understood that the technical problems listed above are only examples rather than limitations to the present disclosure, and that the present disclosure is not limited to a technical solution that simultaneously solves all the above technical problems. The technical solutions of the present disclosure can be implemented to solve one or more of the above or other technical problems.

### SUMMARY OF THE INVENTION

The object of the present disclosure is to solve the problem that the existing human body movement monitoring cannot accurately detect whether there are invalid human body movement records. Since a user's movement is exceptionally complex, it is difficult to accurately determine whether there is a fraudulent movement record or other invalid behaviors by a single dimension information, such as step count.

In one aspect of the present disclosure, a neural network-based method for detecting validity of a human movement is provided, comprising: obtaining a user movement dataset, the user movement dataset comprising a plurality of n-dimensional movement data items corresponding to the human body movement; extracting a feature text based on the user movement dataset, wherein the feature text comprises a plurality of input sequences, and each of the plurality of input sequences comprises at least a direction, a distance, and a step count; transforming the feature text into a first initial encoding according to a preset coding rule; and inputting the first initial encoding into an auto-encoder neural network-based detection model to determine whether the human body movement corresponding to the user movement dataset is valid; wherein the auto-encoder neural network-based detection model comprises an encoder and a decoder, the encoder is configured to map the first initial encoding to an intermediate variable comprising a compressed eigenvector, and the decoder is configured to translate the intermediate variable into a first predicted encoding; wherein determining whether the human body movement corresponding to the user movement dataset is valid further comprises: obtaining a first loss function value based on the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.

Preferably, the detection model is trained by a training dataset, the training dataset comprising a plurality of n-dimensional movement data items corresponding to the human body movement; wherein the training comprises: extracting a feature text based on the training dataset, wherein the feature text comprises a plurality of input sequences, and each of the plurality of the input sequences comprises at least a direction, a distance and a step count; transforming the feature text into a second initial encoding according to a preset coding rule; and in at least one iterative loop, inputting the second initial encoding into the auto-encoder neural network-based detection model to obtain a second predicted encoding, and training the detection model by using a minimization of a second loss function value of the second initial encoding and the predicted encoding as an objective function, until the loss function value is lower than a preset threshold.

Further preferably, the first loss function value is a cross entropy of the first initial encoding and the first predicted encoding. Furthermore, the second loss function value is a cross entropy of the second initial encoding and the second predicted encoding.

Preferably, each of the plurality of n-dimensional movement data items comprises at least longitude information, latitude information, and accumulated steps information. Further preferably, each of the plurality of n-dimensional movement data items further comprises at least one of time information, instantaneous movement speed, and altitude information. Further preferably, each of the plurality of n-dimensional movement data items further comprises at least one of a pulse rate, a body temperature, a blood oxygen value, and a blood pressure value.

Preferably, the method further comprises collecting movement data items at a preset frequency by using at least one sensor in a mobile device to construct the user movement dataset or the training dataset. Preferably, as an alternative, the method comprises collecting movement data items by invoking at least one of a GPS positioning service, an application program, a gyroscope of a smart device, or a combination thereof, to construct one of the training dataset and the user movement dataset.

Preferably, the method comprises dividing the user movement dataset into a plurality of subsets, such that a change rate in at least one of preset dimensions of the plurality of n-dimensional movement data items in each of the plurality of subsets does not exceed a preset value, and determining for each of the plurality of subsets whether a human body movement of the corresponding subset is valid.

Preferably, the method further comprises tagging movement data items collected during a pause period in response to a user's indication to pause a movement, and removing the tagged movement data items when obtaining the user movement dataset.

Preferably, the auto-encoder neural network based detection model is deployed on a device terminal with edge computing capability, and the method is executed by the device terminal.

In the second aspect of the present disclosure, a non-transitory computer-readable medium having stored content is further provided, wherein the stored content causes a computing system to perform automatic operations, comprising: obtaining a user movement dataset, the user movement dataset comprising a plurality of n-dimensional movement data items corresponding to a human body movement; extracting a feature text based on the user movement dataset, wherein the feature text comprises a plurality of input sequences, and each of the input sequences comprises at least a direction, a distance, and a step count; transforming the feature text into a first initial encoding according to a preset coding rule; and inputting the first initial encoding into an auto-encoder neural network-based detection model to determine whether the human body movement corresponding to the user movement dataset is valid; wherein the detection model comprises an encoder and a decoder, the encoder is configured to map the initial encoding to an intermediate variable comprising a compressed eigenvector, and the decoder is configured to translate the intermediate variable into a first predicted encoding; wherein determining whether the human body movement corresponding to the user movement dataset is valid further comprises: obtaining a first loss function value of the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.

In the third aspect of the present disclosure, a system is also provided, comprising: one or more processors; a wireless communication module configured to obtain a user movement dataset; and at least one memory having stored instructions that, when executed by at least one of one or more processors, causes the system to perform automated operations, comprising: obtaining a user movement dataset, the user movement dataset comprising a plurality of n-dimensional movement data items corresponding to a human body movement; extracting a feature text based on the user movement dataset, wherein the feature text comprises a plurality of input sequences, and each of the input sequences comprises at least a direction, a distance, and a step count; transforming the feature text into a first initial encoding according to a preset coding rule; and inputting the first initial encoding into an auto-encoder neural network-based detection model to determine whether the human body movement corresponding to the user movement dataset is valid; wherein the detection model comprises an encoder and a decoder, the encoder is configured to map the first initial encoding to an intermediate variable comprising a compressed eigenvector, and the decoder is configured to translate the intermediate variable into a first predicted encoding; wherein determining whether the human body movement corresponding to the user movement dataset is valid further comprises: obtaining a first loss function value based on the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.

On one hand, according to the solution of the present disclosure, the validity detection model is trained using a large amount of training datasets, which comprise data from sensors, GPS tracking, other personal health information such as blood pressure, etc. On the other hand, the user movement dataset is pre-coded to extract feature text and then input into the auto-encoder neural network-based detection model to determine whether a loss function value based on the initial encoding and the predicted encoding output by the detection code being lower than the preset threshold. Therefore, the solution according to the present disclosure has high scalability, while at the same time allowing comprehensive collection of motion-related data items to serve as a data basis. By assessing whether the user movement dataset is invalid or not, and further identifying any violation behavior that lead to invalidation, the accuracy rate of identifying invalid behaviors can be improved while reducing the false alarm rate.

### BRIEF DESCRIPTION OF THE DRAWINGS

FIG. 1 illustrates a schematic flow diagram of a method for detecting the validity of human body movement according to an embodiment of the present disclosure;

FIG. 2 illustrates a schematic flow chart of a method for detecting the validity of human body movement according to another embodiment of the present disclosure;

FIG. 3 illustrates a schematic diagram of an auto-encoder neural network according to an embodiment of the present disclosure;

FIG. 4 illustrates a schematic flow chart of a process for applying a detection model to a user movement dataset to detect validity according to an embodiment of the present disclosure; and

FIG. 5 illustrates a schematic diagram of a system according to an embodiment of the present disclosure.

### DESCRIPTION OF THE PREFERRED EMBODIMENTS

The method of the present disclosure will be described in detail below with reference to the accompanying drawings and specific embodiments. It should be understood that the embodiments shown in the accompanying drawings and described below are merely illustrative and are not intended to be a limitation of the present disclosure.

Users may carry mobile devices such as smartphones or wearables with them when they are on the move, such as walking, jogging, cycling, and running. Such mobile devices are usually configured with various types of sensors, such as accelerometers, gyroscopes, magnetometers, etc., which can be used to obtain information about the user's movement, such as step counts, movement speed, etc.; and configured with distance monitoring components, such as GPS module, which can be used to measure the user's movement in real time, such as moving direction, moving distance, longitude and latitude information, etc.. At the end of the movement, the user can choose to stop recording the corresponding user movement data, and various types of movement data information generated during the movement can be aggregated for further recording or analysis.

To encourage people to move around in the real world, people's movements can be tracked and rewarded, for example, users earn rewards for their movements, wherein such rewards can comprise but are not limited to gift cards, vouchers, virtual currency, cryptocurrencies such as tokens or coins, etc.

However, some participants may try to cheat to get more rewards. Such cheating behavior can affect the confidence and motivation of other participants. Therefore, in order to ensure fairness, the validity of such movement data needs to be assessed to flag invalid movement records generated by any cheating behavior.

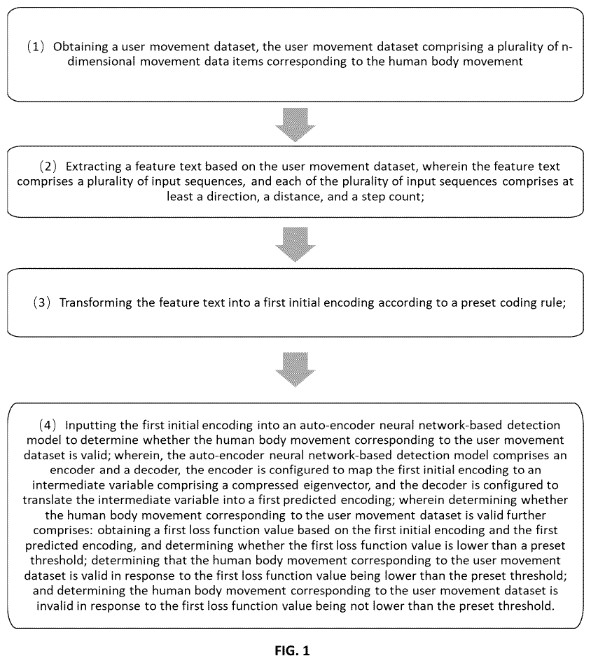

In a first aspect, a neural network-based method for detecting validity of a human movement is disclosed, as shown in FIG. 1, comprising:
(1) Obtaining a user movement dataset, the user movement dataset comprising a plurality of n-dimensional movement data items corresponding to the human body movement;
(2) Extracting a feature text based on the user movement dataset, wherein the feature text comprises a plurality of input sequences, and each of the plurality of input sequences comprises at least a direction, a distance, and a step count;
(3) Transforming the feature text into a first initial encoding according to a preset coding rule; and
(4) Inputting the first initial encoding into an auto-encoder neural network-based detection model to determine whether the human body movement corresponding to the user movement dataset is valid; wherein, the auto-encoder neural network-based detection model comprises an encoder and a decoder, the encoder is configured to map the first initial encoding to an intermediate variable comprising a compressed eigenvector, and the decoder is configured to translate the intermediate variable into a first predicted encoding; wherein determining whether the human body movement corresponding to the user movement dataset is valid further comprises: obtaining a first loss function value based on the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.

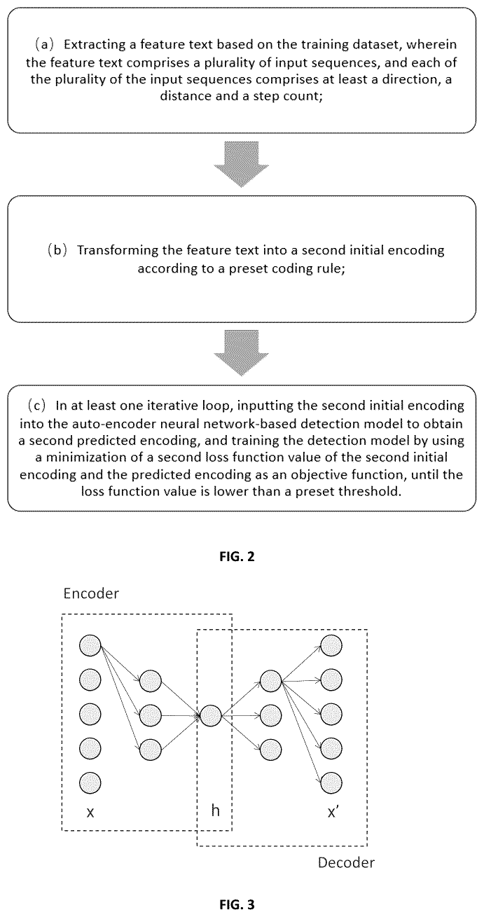

The neural network-based method for detecting validity of a human movement according to the present disclosure, as shown in FIG. 2, further comprises: training the detection model by a training dataset, the training dataset comprising a plurality of n-dimensional movement data items corresponding to the human body movement; wherein the training comprises:
(a) Extracting a feature text based on the training dataset, wherein the feature text comprises a plurality of input sequences, and each of the plurality of the input sequences comprises at least a direction, a distance and a step count;
(b) Transforming the feature text into a second initial encoding according to a preset coding rule; and
(c) In at least one iterative loop, inputting the second initial encoding into the auto-encoder neural network-based detection model to obtain a second predicted encoding, and training the detection model by using a minimization of a second loss function value of the second initial encoding and the predicted encoding as an objective function, until the loss function value is lower than a preset threshold.

The above methods are general exemplary embodiments of the method for detecting human body movement validity, and the steps will be described in more detail below.

### Auto-Encoder Neural Network-Based Detection Model

### A. Pre-Coding

Each of the user motion dataset and the training dataset comprises a plurality of n-dimensional movement data items corresponding to a human body movement. In some embodiments, each of the plurality of n-dimensional movement data items comprises at least longitude information, latitude information, and accumulated steps information. In some other embodiments, each of the plurality of n-dimensional movement data items further comprises at least one of time information, instantaneous movement speed, and altitude information. Further preferably, each of the plurality of n-dimensional movement data items further comprises at least one of a pulse rate, a body temperature, a blood oxygen value, and a blood pressure value.

The pre-encoding process comprises: (1) Extracting a feature text based on the user movement dataset, wherein the feature text comprises a plurality of input sequences. Specifically, a plurality of input sequences are extracted according to n-dimensional movement data items in the user movement dataset, and each of the plurality of input sequence comprises at least a direction, a distance and a step count. As an example, three of the obtained input sequences are “2 meters and 3 steps towards the southwest; 1 meter and 2 steps towards the west; and 4 meters and 7 steps towards the southwest”. (2) Transforming the feature text into a first initial encoding according to a preset coding rule. In some embodiments, a coding rule can be customized. For example, the direction in the input sequence is encoded as a numerical value ranging from 1 to 8. As an example, the coding rule for direction is shown in Table 1 as below.

| Direction | Code |
|---|---|
| North | 1 |
| Northeast | 2 |
| East | 3 |
| Southeast | 4 |
| South | 5 |
| Southwest | 6 |
| West | 7 |
| Northwest | 8 |

As an example, the distance in the input sequence can be encoded as a numerical value ranging from 101 to 200. As an example, the step count in the input sequence can be encoded as a numerical value ranging from 201 to 300. As shown in Table 2 as below, the above exemplary input sequence “2 meters and 3 steps towards the southwest; 1 meter and 2 steps towards the west; and 4 meters and 7 steps towards the southwest” will be encoded as the following initial encoding:

| Input Sequence | Initial Encoding |
|---|---|
| 2 meters and 3 steps towards the southwest | 6 102 203 |
| 1 meter and 2 steps towards the west | 7 101 202 |
| 4 meters and 7 steps towards the southwest | 6 104 207 |

Through the above pre-encoding operation, the feature text comprising multiple input sequences can be extracted based on the user movement dataset, and the feature text can be transformed into a first initial encoding according to a preset coding rule for further input into the auto-encoder neural network-based detection model for validity detection.

### B. Training the Auto-Encoder Neural Network-Based Detection Model

An auto-encoder is a neural network that comprises an encoder, a decoder, and a loss function. The encoder and the decoder are generally parameterized equations and are derivable with respect to the loss function. Typically, a neural network to build an encoder and a decoder. For example, as shown in FIG. 3, an auto-encoder can consist of two cascaded networks.

Where, the first network is used for the encoder, which is responsible for receiving the initial encoding x, and mapping the initial encoding x to an intermediate variable h according to a function h=f (x), where the intermediate variable h comprises a compressed eigenvector.

Where, the second network is used for the decoder, which is responsible for taking the intermediate variable h as an input and reconstructing the intermediate variable into a predicted encoding x′ according to the function x′=g (h)=g(f(x)).

The role of the encoder is to convert the input high-dimensional initial encoding into a low-dimensional intermediate variable to force the neural networks to learn the most informative features of the initial encoding, while the role of the decoder is to restore the intermediate variable to the original dimensions of the initial encoding. The best state of the trained auto-encoder is that the output of the decoder can approximately reconstruct the intermediate variable into the original input of the initial encoding, that is, achieving a status where predicted encoding x′ ˜ initial encoding x. Therefore, in the process of training the auto-encoder, a loss function is used to determine the error between the initial encoding and the predicted encoding, that is, the value of the loss function, which is used as an optimization target of the training. For example, the loss function can be a cross-entropy function, and the purpose of auto-encoder training is to minimize the cross-entropy value between the initial encoding and the predicted encoding.

According to an embodiment of the present disclosure, the auto-encoder neural network-based detection model can be trained by a training dataset. Wherein the training dataset comprises a plurality of n-dimensional movement data items corresponding to a human body movement. The above-mentioned pre-coding process is performed on the training dataset, wherein the pre-coding process comprising: extracting a feature text based on the training dataset, wherein the feature text comprises a plurality of input sequences, and each of the plurality of input sequence comprises at least a direction, a distance and a step count; and transforming the feature text into a second initial encoding according to a preset coding rule. In at least one iterative loop, the second initial encoding is input into the auto-encoder neural network-based detection model to obtain a second predicted encoding, and the detection model is trained by using a minimization of a second loss function value of the second initial encoding and the predicted encoding as an objective function, until the loss function value is lower than a preset threshold.

After the above training, the dimensions of the compressed eigenvector contained in the intermediate variable finally output by the encoder of the detection model are small enough, and the compressed eigenvector can record the key features of the input sequence, that is, the features contained in the training dataset corresponding to the valid human body movement can be recorded. When the user movement dataset input into the detection model corresponds to abnormal behavior, for example, when the input is movement data items generated by invalid human movement, the predicted encoding output from the detection model will be significantly different from the initial encoding, and will not be restored to the initial encoding or a similar encoding.

### C. Detecting Validity by the Auto-Encoder Neural Network-Based Detection Model

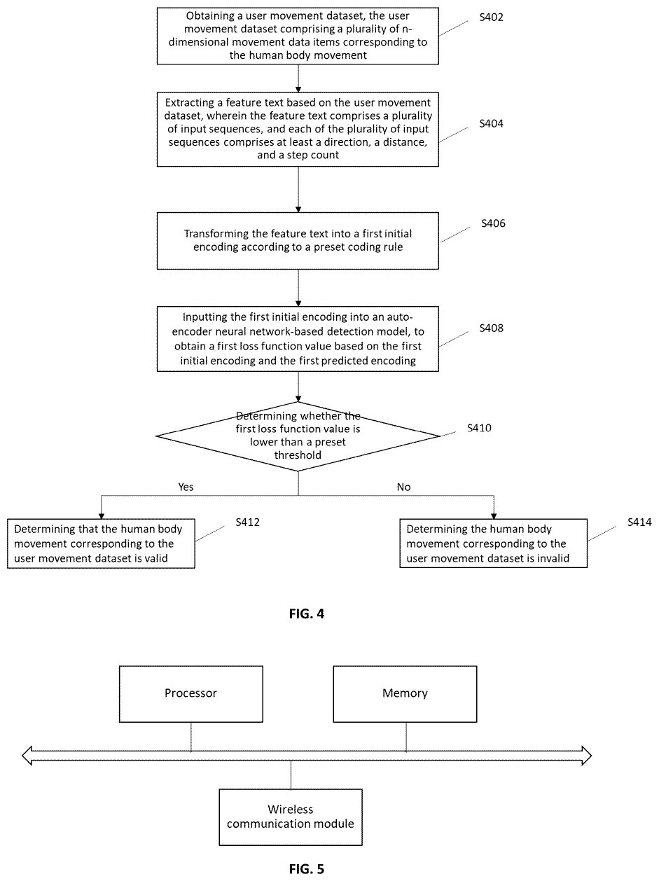

According to an embodiment of the present disclosure, specifically, as shown in FIG. 4, the main steps of applying an auto-encoder neural network-based detection model to detect validity of a user movement dataset are illustrated. First, an initial encoding is obtained according to the user movement dataset with reference to the method in the pre-coding process described above. Wherein the pre-coding process comprises: in step S402, obtaining a user movement dataset, the user movement dataset comprising a plurality of n-dimensional movement data items corresponding to the human body movement; in step S404, extracting a feature text based on the user movement dataset, wherein the feature text comprises a plurality of input sequences, and each of the plurality of input sequences comprises at least a direction, a distance, and a step count; in step S406, transforming the feature text into a first initial encoding according to a preset coding rule.

Next, in step S408, the first initial encoding is input into an auto-encoder neural network-based detection model to determine whether the human body movement corresponding to the user movement dataset is valid. For example, the detection model has been trained with a large number of training datasets according to the above-mentioned model training process. Wherein determining whether the human body movement corresponding to the user movement dataset is valid further comprises: obtaining a first loss function value based on the first initial encoding and the first predicted encoding; and in step S410, determining whether the first loss function value is lower than a preset threshold; in step S412, determining that the human body movement corresponding to the user movement dataset is valid in response to the first loss function value being lower than the preset threshold; and in step S414, determining the human body movement corresponding to the user movement dataset is invalid in response to the first loss function value being not lower than the preset threshold. The initial encoding is denoted as A, the output predicted encoding is denoted asA′, and the loss function value of the initial encoding and the predicted encoding is obtained. For example, if the loss function is a cross entropy function, the obtained loss function value Loss is calculated according to the formula Loss=crossEntropy(A′, A), wherein crossEntropy is the cross entropy function. The human body movement corresponding to the user movement dataset is determined as valid in response to the loss function value Loss being lower than the preset threshold; and the human body movement corresponding to the user movement dataset is determined as invalid in response to the loss function value Loss being not lower than the preset threshold.

According to the solutions in the embodiments of the present disclosure, an auto-encoder neural network-based method for detecting validity of human body movement is provided. The method uses an auto-encoder neural network-based detection model that does not require a lot of time for analyzing the raw data, and does not require complex computation of eigenvectors. The method of the present disclosure reduces the complexity of computation, and can be applied to scenarios with large-scale data volume and high-dimensional features. The present disclosure creatively extracts a feature text from the movement data item and transforms it into an initial encoding, and inputs the initial encoding into a trained auto-encoder neural network-based detection model, which maps the initial encoding to an intermediate variable by an encoder and then translate the intermediate variable into a predicted encoding by a decoder, thus obtaining the validity detection result of the user movement dataset by determining whether a loss function value based on the initial encoding and the predicted encoding is lower than a preset threshold. The solutions in the embodiments of the present disclosure, unlike traditional detection methods, do not need to perform complicated feature extraction, feature combination and other operations before performing the detection model training. By converting movement data items into feature texts, the solutions in the embodiments of the present disclosure significantly reduce the computation complexity and improve the accuracy of detection results. Moreover, the technical solutions of the present disclosure do not need to limit the data dimensions, and can automatically mine the features contained in the valid human body movement dataset from the training dataset and then apply to the detection model through training, improving the performance and effectiveness of validity detection.

In some embodiments, a large number of human body movements that have been validated as valid are tracked to obtain a training dataset, wherein the n-dimensional movement data items in the training dataset conform to a natural distribution law, such as a normal distribution, in terms of movement speed, moving mode, etc.

In some optimized embodiments, the training dataset comprises a movement dataset corresponding to the user's past human body movements that have been validated as valid. By taking the movement dataset corresponding to the user's past valid human body movement as a training dataset, the auto-encoder neural network-based detection model can be trained for continuous optimization and finally achieve a more accurate determination for users.

In some embodiments, the user movement dataset can be divided into a plurality of subsets, such that a change rate in at least one of preset dimensions of the plurality of n-dimensional movement data items in each of the plurality of subsets does not exceed a preset value. Each of the plurality of subsets is detected to determine whether a human body movement of the corresponding subset is valid. The actual movement of the user can be more complicated. For example, the user can walk for a portion of the distance and run or cycle for another portion of the distance in the movement. For such situations, according to the method of the present disclosure, the collected user movement dataset can be divided into subsets depending on whether the movement speed or any other dimension has a sudden change, and each of the divided subsets can be evaluated to verify its validity, so as to obtain more objective detection results.

In some embodiments, in response to a user's indication that the movement is paused, the movement data items collected during the pause can be tagged, and the tagged movement data items collected during the pause can be removed when obtaining the user movement dataset. The user may experience subjective or non-subjective pauses in motion during movement, which can adversely affect the effectiveness of validity detection if the movement data items during the pause period continue to be collected and aggregated into the user movement dataset. In some cases, the mobile device can be instructed to pause the collection of movement data items during the pause in a movement, or alternatively, to tag the movement data items collected during the pause and remove the tagged movement data items from the user movement dataset during preprocessing. For example, the user can issue an instruction to pause movement via the mobile device, and then issue an instruction to resume movement after a period of time. The mobile data items collected during the pause based on the time stamps corresponding to the instruction to pause the movement and the instruction to resume the movement are removed from the user motion dataset.

### Deploying the Validity Detection Model

In some embodiments, the validity detection model can be deployed on a remote server, where the user movement dataset is uploaded to the server to execute the validity detection method.

In some other embodiments, the validity detection model can be deployed on a device terminal with edge computing capability, where the user movement dataset is stored locally, and the validity detection method is executed by the device terminal.

It is understandable that the term “server” may not necessarily be in the form of a single physical machine, but may also be, for example, a distributed or cloud computing service, engine, or platform.

In a second aspect, a non-transitory computer-readable medium is disclosed, which has stored content that causes a computing system to perform automated operations, comprising: Obtaining a user movement dataset, the user movement dataset comprising a plurality of n-dimensional movement data items corresponding to a human body movement; extracting a feature text based on the user movement dataset, wherein the feature text comprises a plurality of input sequences, and each of the input sequences comprises at least a direction, a distance, and a step count; transforming the feature text into a first initial encoding according to a preset coding rule; and inputting the first initial encoding into an auto-encoder neural network-based detection model to determine whether the human body movement corresponding to the user movement dataset is valid; wherein the detection model comprises an encoder and a decoder, the encoder is configured to map the initial encoding to an intermediate variable comprising a compressed eigenvector, and the decoder is configured to translate the intermediate variable into a first predicted encoding.

Wherein determining whether the human body movement corresponding to the user movement dataset is valid further comprises: obtaining a first loss function value of the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.

In a third aspect, as shown in FIG. 5, a system is disclosed, comprising: one or more processors; a wireless communication module configured to obtain a user movement dataset; and at least one memory having stored instructions that, when executed by at least one of the one or more processors, cause the system to perform automated operations, comprising: Obtaining a user movement dataset, the user movement dataset comprising a plurality of n-dimensional movement data items corresponding to a human body movement; extracting a feature text based on the user movement dataset, wherein the feature text comprises a plurality of input sequences, and each of the input sequences comprises at least a direction, a distance, and a step count; transforming the feature text into a first initial encoding according to a preset coding rule; and inputting the first initial encoding into an auto-encoder neural network-based detection model to determine whether the human body movement corresponding to the user movement dataset is valid; wherein the detection model comprises an encoder and a decoder, the encoder is configured to map the first initial encoding to an intermediate variable comprising a compressed eigenvector, and the decoder is configured to translate the intermediate variable into a first predicted encoding. Wherein determining whether the human body movement corresponding to the user movement dataset is valid further comprises: obtaining a first loss function value of the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.

In summary, the method of the present disclosure does not require complex feature extraction process on the original dataset, but only uses a large number of training datasets corresponding to valid human body movements to train the auto-encoder neural network-based detection model, inputs the feature text of user movement dataset obtained through pre-coding process into the validity detection model, and determines whether the human body movement corresponding to the user movement dataset is valid based on the difference between the predicted encoding and the initial encoding. The method according to the present disclosure can improve the detection accuracy and ensure the efficiency of execution while reducing the false alarm rate.

While various embodiments of aspects of the disclosure have been described for the purposes of the present disclosure, it should not be construed that the teachings of the present disclosure are limited to these embodiments. The features disclosed in a specific embodiment are not limited to the embodiment, but can be combined with features disclosed in different embodiments. For example, one or more features and/or operations of the method according to the present disclosure described in one embodiment may also be applied individually, in combination or as a whole in another embodiment. Furthermore, it should be understood that the method steps described above can be performed sequentially, in parallel, combined into fewer steps, split into more steps, combined and/or omitted in a manner other than described. It should be understood by those skilled in the art that further optional embodiments and variants are possible, and that various changes and modifications can be made to the method steps described above without departing from the scope defined by the claims of the present disclosure.

1. A neural network-based method for detecting validity of a human movement, comprising,
obtaining a user movement dataset, the user movement dataset comprising a plurality of n-dimensional movement data items corresponding to the human body movement;
extracting a feature text based on the user movement dataset, wherein the feature text comprises a plurality of input sequences, and each of the plurality of input sequences comprises at least a direction, a distance, and a step count;
transforming the feature text into a first initial encoding according to a preset coding rule; and
inputting the first initial encoding into an auto-encoder neural network-based detection model to determine whether the human body movement corresponding to the user movement dataset is valid; wherein the auto-encoder neural network-based detection model comprises an encoder and a decoder, the encoder is configured to map the first initial encoding to an intermediate variable comprising a compressed eigenvector, and the decoder is configured to translate the intermediate variable into a first predicted encoding; wherein determining whether the human body movement corresponding to the user movement dataset is valid further comprises:
obtaining a first loss function value based on the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.

2. The method according to claim 1, further comprising
training the detection model by a training dataset, the training dataset comprising a plurality of n-dimensional movement data items corresponding to the human body movement;
wherein the training comprises:
extracting a feature text based on the training dataset, wherein the feature text comprises a plurality of input sequences, and each of the plurality of the input sequences comprises at least a direction, a distance and a step count;
transforming the feature text into a second initial encoding according to a preset coding rule; and
in at least one iterative loop, inputting the second initial encoding into the auto-encoder neural network-based detection model to obtain a second predicted encoding, and training the detection model by using a minimization of a second loss function value of the second initial encoding and the predicted encoding as an objective function, until the loss function value is lower than a preset threshold.

3. The method according to claim 1, wherein
the first loss function value is a cross entropy of the first initial encoding and the first predicted encoding.

4. The method according to claim 2, wherein
the second loss function value is a cross entropy of the second initial encoding and the second predicted encoding.

5. The method according to claim 1, wherein
each of the plurality of n-dimensional movement data items comprises at least longitude information, latitude information, and accumulated steps information.

6. The method according to claim 5, wherein
each of the plurality of n-dimensional movement data items further comprises at least one of time information, instantaneous movement speed, and altitude information.

7. The method according to claim 5, wherein
each of the plurality of n-dimensional movement data items further comprises at least one of a pulse rate, a body temperature, a blood oxygen value, and a blood pressure value.

8. The method according to claim 2, further comprising
collecting movement data items at a preset frequency by using at least one sensor in a mobile device to construct the user movement dataset or the training dataset.

9. The method according to claim 2, further comprising
collecting movement data items by invoking at least one of a GPS positioning service, an application program, a gyroscope of a smart device, or a combination thereof, to construct one of the training dataset and the user movement dataset.

10. The method according to claim 1, further comprising
dividing the user movement dataset into a plurality of subsets, such that a change rate in at least one of preset dimensions of the plurality of n-dimensional movement data items in each of the plurality of subsets does not exceed a preset value, and determining for each of the plurality of subsets whether a human body movement of the corresponding subset is valid.

11. The method according to claim 1, further comprising
tagging movement data items collected during a pause period in response to a user's indication to pause a movement, and removing the tagged movement data items when obtaining the user movement dataset.

12. The method according to claim 1, wherein
the auto-encoder neural network based detection model is deployed on a device terminal with edge computing capability, and the method is executed by the device terminal.

13. A non-transitory computer-readable medium having stored content, wherein the stored content causes a computing system to perform automated operations, comprising:
obtaining a user movement dataset, the user movement dataset comprising a plurality of n-dimensional movement data items corresponding to a human body movement;
extracting a feature text based on the user movement dataset, wherein the feature text comprises a plurality of input sequences, and each of the input sequences comprises at least a direction, a distance, and a step count;
transforming the feature text into a first initial encoding according to a preset coding rule; and
inputting the first initial encoding into an auto-encoder neural network-based detection model to determine whether the human body movement corresponding to the user movement dataset is valid; wherein the detection model comprises an encoder and a decoder, the encoder is configured to map the initial encoding to an intermediate variable comprising a compressed eigenvector, and the decoder is configured to translate the intermediate variable into a first predicted encoding; wherein determining whether the human body movement corresponding to the user movement dataset is valid further comprises:
obtaining a first loss function value of the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.

14. A system, comprising:
one or more processors;
a wireless communication module configured to obtain a user movement dataset;
and at least one memory having stored instructions that, when executed by at least one of the one or more processors, cause the system to perform automated operations comprising:
obtaining a user movement dataset, the user movement dataset comprising a plurality of n-dimensional movement data items corresponding to a human body movement;
extracting a feature text based on the user movement dataset, wherein the feature text comprises a plurality of input sequences, and each of the input sequences comprises at least a direction, a distance, and a step count;
transforming the feature text into a first initial encoding according to a preset coding rule; and
inputting the first initial encoding into an auto-encoder neural network-based detection model to determine whether the human body movement corresponding to the user movement dataset is valid; wherein the detection model comprises an encoder and a decoder, the encoder is configured to map the initial encoding to an intermediate variable comprising a compressed eigenvector, and the decoder is configured to translate the intermediate variable into a first predicted encoding; wherein determining whether the human body movement corresponding to the user movement dataset is valid further comprises:
obtaining a first loss function value based on the first initial encoding and the first predicted encoding, and determining whether the first loss function value is lower than a preset threshold; determining that the human body movement corresponding to the user movement dataset is valid in response to the first loss function value being lower than the preset threshold; and determining the human body movement corresponding to the user movement dataset is invalid in response to the first loss function value being not lower than the preset threshold.
